(19) United States
(12) Patent Application Publication
(10) Pub. No.: US 2011/0150652 A1
(43) Pub. Date: Jun. 23, 2011

(54) TURBINE ASSEMBLIES

(75) Inventors: Mark Rydell Cosby, Goshen, IN (US); Roderic Alan Schlabach, Goshen, IN (US)

(73) Assignee: Lucid Energy Technologies, LLP, Goshen, IN (US)

(21) Appl. No.: 12/644,739

(22) Filed: Dec. 22, 2009

(51) Int. Cl. F03D 11/04; B23P 11/00; F03D 3/00

(52) U.S. Cl. 416/142; 29/889

(57) ABSTRACT

A turbine is described. The turbine includes: (i) a shaft capable of rotation along its longitudinal axis and capable of connecting to an electrical generator, and the shaft having disposed thereon at least one shaft hinge; (ii) a radial arm including a first end having disposed thereon at least one first hinge; and a hinge pin that fits inside a cavity formed when at least one the shaft hinge of the shaft is in an engaged position with at least one first hinge of the radial arm, and in the engaged position the hinge pin capable of connecting the radial arm to the shaft.

### BACKGROUND OF THE INVENTION

The present invention relates generally to turbine assemblies useful for harnessing wind and hydrokinetic energy. More particularly, the present invention relates to improved turbine assemblies, which are easy to assemble and service and used for wind and hydrokinetic energy applications.

FIG. 1 shows a conventional turbine assembly 10 used for generating wind energy. Assembly 10 includes a single-piece construction of the radial arm and blade 12 with a bolted connection to a hub 14 that is mounted on a longitudinal shaft 16. Wind acts upon the blade and causes them to move, generating electricity.

Unfortunately, the conventional turbine assembly suffers from several drawbacks. By way of example, installing conventional turbine assemblies is a long and arduous task. Specifically, installing a single-piece-blade-and-radial-arm design to a hub is a time-consuming task. As another example, such an installation requires specialized equipment.

As yet another example, shipping of the conventional single-piece design is also difficult because the parts are large, odd-shaped, and difficult to package close together. Furthermore, due to the complex nature of construction of the conventional design, the cost of replacement pieces is high. Further still, the conventional design precludes non-conventional material utilization due to fatigue issues.

What is therefore needed is an improved system and method of assembling a turbine assembly which does not suffer from the drawbacks encountered by conventional designs.

### SUMMARY OF THE INVENTION

In view of the foregoing, this invention provides novel systems and methods for harnessing wind and hydrokinetic energy with an improved turbine-assembly design which are easy to assemble and service.

In one aspect, the present invention provides a turbine. The turbine includes: (i) a shaft capable of rotation along its longitudinal axis and capable of connecting to an electrical generator, and the shaft having disposed thereon at least one shaft hinge; (ii) a radial arm including a first end having disposed thereon at least one first hinge; and (iii) a hinge pin that fits inside a cavity formed when the at least one shaft hinge of the shaft is in an engaged position with the at least one first hinge of the radial arm, and in the engaged position the hinge pin capable of connecting the radial arm to the shaft.

In certain embodiments of the present invention, the turbine includes a securing mechanism for immobilizing the hinge pin when it fits inside the cavity. The hinge pin is preferably a barrel-shaped body having at a first end a head portion and having defined at a second end an aperture which extends along a diameter of the hinge pin at the second end, and wherein the securing mechanism includes a securing pin which is capable of being inserted through the aperture when the hinge pin is inside the cavity in the engaged position. The securing mechanism may also include a washer, and in the engaged position, the hinge pin capable of being passed through the washer before the securing pin is inserted through the aperture.

The inventive turbine may also include a fastening assembly which includes a clamp portion and a hinge portion, the clamp portion capable of engaging with or being connected to a blade component of the turbine and the hinge portion engaging with at least one hinge disposed at a second end of the radial arm. Preferably, the blade has a helical shape.

In another aspect, the present invention provides another turbine. The turbine includes: (i) a radial arm including a first end and a second end, the radial arm at the first end is capable of connecting to a shaft that is capable of rotation along its longitudinal axis and capable of connecting to an electrical generator, and the radial arm at the second end has disposed thereon at least one second hinge; (ii) a blade that includes or has connected thereto the blade hinge; and (iii) a hinge pin that fits inside a cavity formed when the blade hinge is in an engaged position with at least one the second hinge of the radial arm, and in the engaged position the hinge pin capable of connecting the radial arm to the shaft. Preferably, the blade has a helical shape.

In certain embodiments, the present invention further includes a securing mechanism for immobilizing the hinge pin when it fits inside the cavity. Preferably, the hinge pin is a barrel-shaped body having at a first end a head portion and having defined at a second end an aperture which extends along a diameter of the hinge pin at the second end, and wherein the securing mechanism includes a securing pin which is capable of being inserted through the aperture when the hinge pin is inside the cavity in the engaged position. The securing mechanism may include a washer, and in the engaged position, the hinge pin capable of being passed through the washer before the securing pin is inserted through the aperture.

In preferred embodiments of the present invention, the blade is connected to the blade hinge by a fastening assembly which includes a clamp portion and a hinge portion, the clamp portion capable of engaging with and being secured on the blade and the hinge portion including a blade hinge that engages with at least one first hinge disposed at a first end of the radial arm. Preferably, the clamp portion has two legs and when the clamp portion engages with the blade, the two legs are immobilized using a u-shaped bolt.

In yet another aspect, the present invention provides a shaft. The shaft is capable of rotation along its longitudinal axis and includes a first end and a second end. The first end is capable of connecting to an electrical generator, and the second end has at least one shaft hinge that is designed to connect to at least one hinge disposed on a radial arm. The shaft may include a second end that includes three shaft hinges thereon, each shaft hinge connects to at least one hinge disposed on the radial arm. The radial arm may include a first end and a second end, the first end includes a first hinge and a second end includes a second hinge, the first hinge is capable of connecting to a shaft hinge which is part of or connected to a shaft, and the second hinge is capable of connecting to a blade hinge which is part of or connected to a blade. Preferably, the radial arm is made from at least one material selected from a group consisting of aluminum, fiber glass, carbon fiber, or fiber-reinforced plastic.

In yet another aspect, the present invention discloses a fastening assembly. The fasting assembly includes (i) a clamp portion; (ii) a hinge portion; and (iii) wherein the clamp portion is capable of engaging with or being connected to a blade and the hinge portion is capable of engaging with at least one hinge disposed at one end of a radial arm. The fastening assembly may also include a u-shaped bolt, wherein the clamp portion includes two legs that are immobilized using the u-shaped bolt.

In yet another aspect, the present invention discloses a method of assembling a turbine. The method includes: (i) obtaining a fastener having a clamp portion and a hinge portion, the clamp portion capable of engaging with a blade and the hinge portion including a blade hinge; (ii) securing the clamp portion around the blade by engaging the clamp portion around the blade; (iii) engaging blade hinge with at least one second hinge disposed on a radial arm; and (iv) inserting a hinge pin through a cavity formed when the blade hinge engages with at least one the second hinge disposed on a radial arm and thereby connecting the blade to the radial arm. Preferably, the at least one second hinge is part of or connected to the radial arm. Securing may include: (i) inserting the blade through a u-shaped clamp with two legs; and (ii) tightening the two legs to immobilize the fastener on the blade. Preferably, tightening includes using a u-shaped bolt to clamp the two legs. Preferred embodiments of the present invention may further include the step of immobilizing the hinge pin inside the cavity after the inserting the hinge pin through the cavity. Preferred embodiments of the present invention may yet further include the step of connecting at least one first hinge on the radial arm to a shaft which is capable of rotation around its longitudinal axis and capable of connecting to an electrical generator.

In yet another aspect, the present invention discloses another method for assembling a turbine. The method includes: (i) obtaining a shaft having thereon at least one shaft hinge; (ii) engaging at least one the shaft hinge with at least one first hinge disposed on a radial arm; and (iii) inserting a hinge pin through a cavity formed when the shaft hinge engages with at least one the first hinge disposed on a radial arm and thereby connecting the shaft to the radial arm. Preferably, the at least one the first hinge is part of or connected to the radial arm. Preferred embodiments of the present invention may include the further step of immobilizing the hinge pin inside the cavity after the inserting the hinge pin through the cavity.

The construction and method of operation of the invention, however, together with additional objects and advantages thereof will be best understood from the following descriptions of specific embodiments when read in connection with the accompanying figures.

### BRIEF DESCRIPTION OF THE DRAWINGS

FIG. 1 shows a conventional turbine assembly.

FIG. 2 shows a perspective view of an improved turbine assembly design, according to one embodiment of the present invention, for generating energy.

FIG. 3 shows a top view of the improved turbine assembly design of FIG. 2.

FIG. 4 shows an exploded perspective view of a turbine assembly, according to one embodiment of the present invention.

FIG. 5 shows a turbine subassembly, according to one embodiment of the present invention, which includes a helical blade component that is connected to a radial arm component.

FIG. 6 shows a detailed perspective view of a radial arm component, according to one embodiment of the present invention.

FIG. 7A shows a detailed perspective view of a connection shown in FIG. 5.

FIG. 7B shows a clamp design, according to one embodiment of the present invention, which at one end is fitted on a helical blade component and at a second end engages with a hinge disposed on a radial arm component.

FIG. 8A shows a detailed perspective view of a connection, according to one embodiment of the present invention, between a radial arm component and a shaft of an inventive turbine assembly.

FIG. 8B shows a radial arm component engaged, in accordance with one embodiment of the present invention, with a shaft.

FIG. 9 shows a detailed top view of the turbine assembly design of FIG. 3.

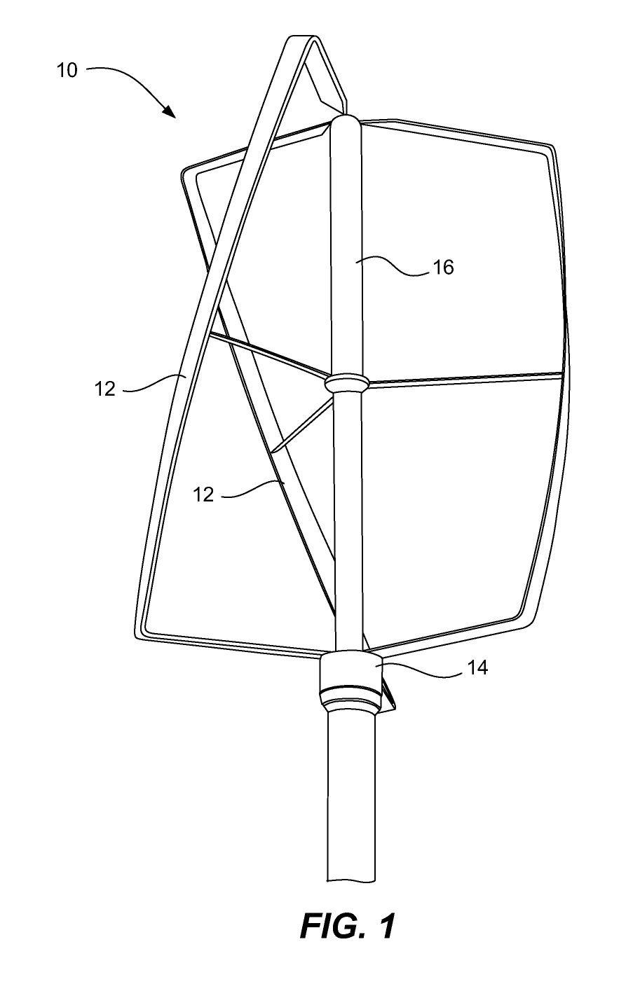

### DETAILED DESCRIPTION OF THE PREFERRED EMBODIMENTS

In the following description numerous specific details are set forth in order to provide a thorough understanding of the present invention. It will be apparent, however, to one skilled in the art that the present invention may be practiced without limitation to some or all of these specific details. In other instances, well known process steps have not been described in detail in order to not unnecessarily obscure the invention.

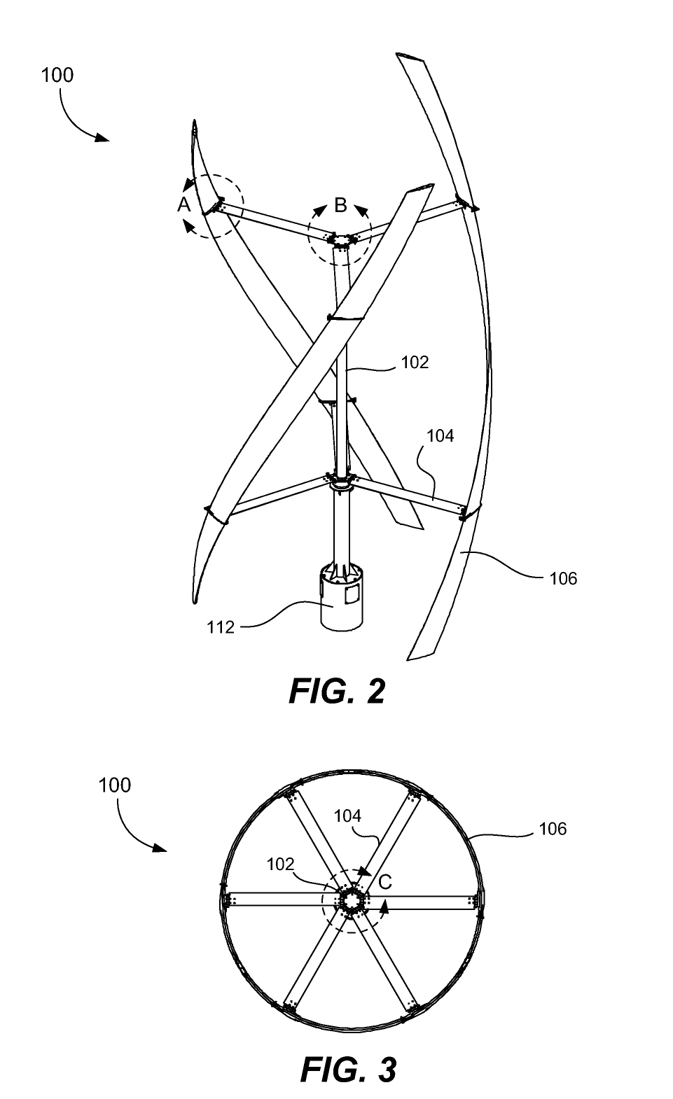

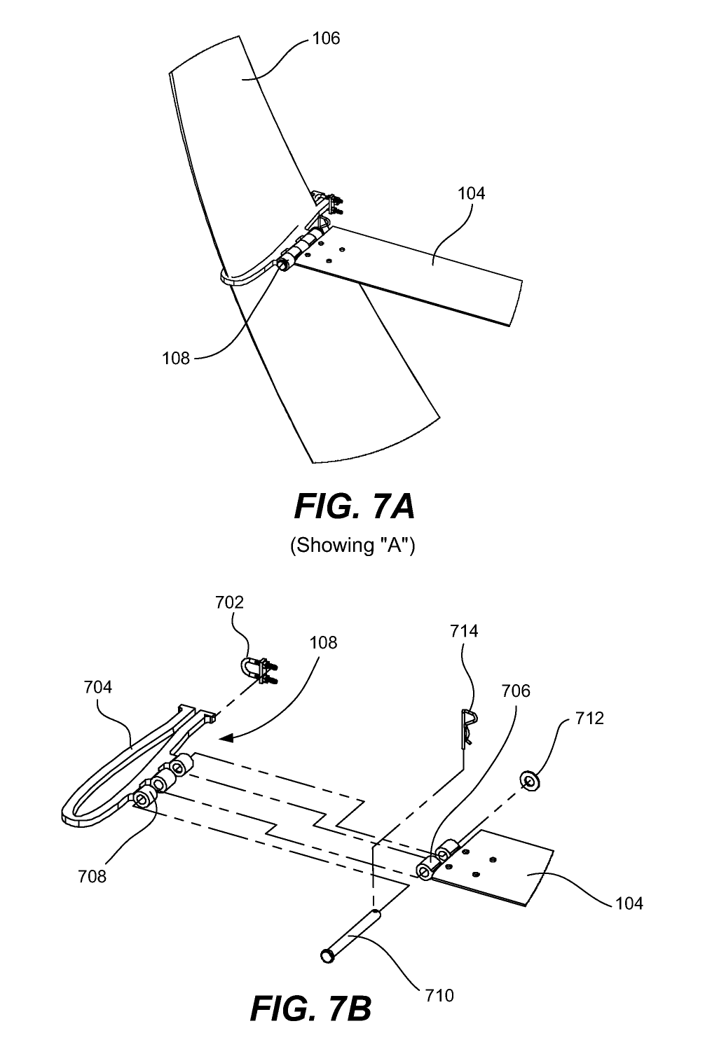

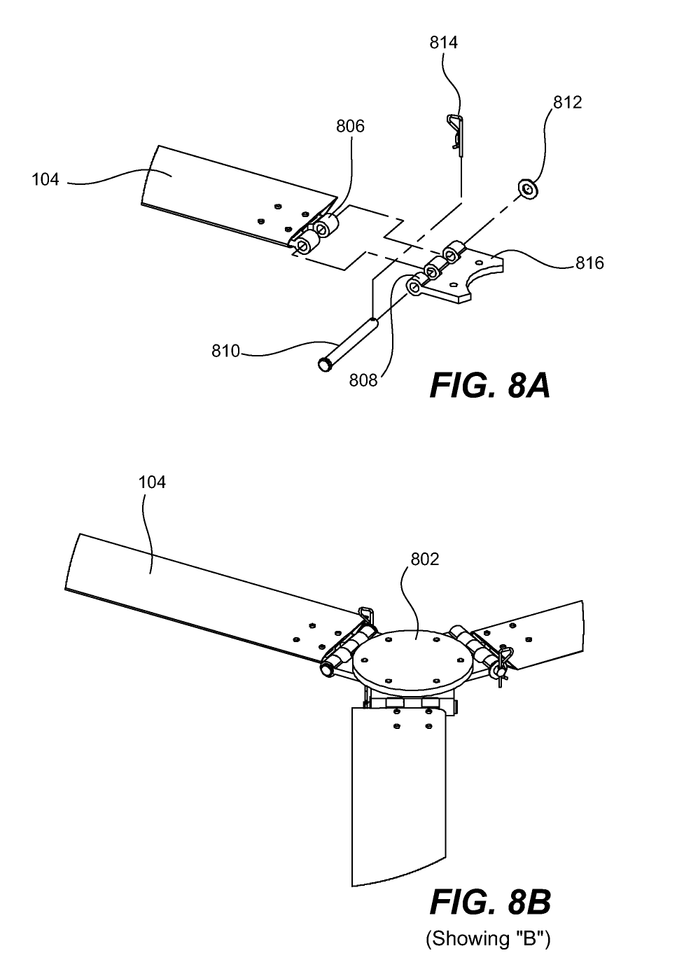

FIG. 2 shows a perspective view of a turbine 100, according to one embodiment of the present invention, used for harnessing wind or hydrokinetic energy to generate electricity. Turbine 100 includes a shaft 102, a radial arm 104 and a blade 106. As will be explained in greater detail below, shaft 102 connects to radial arm 104, which in turn connects to blade 106. To this end, a connection between shaft 102 and radial arm 104 denoted by “B” in FIG. 2 is shown in greater detail in FIGS. 8A and 8B. Similarly, a connection between radial arm 104 and blade 106 denoted by “A” in FIG. 2 is shown in greater detail in FIGS. 7A and 7B. FIG. 2 shows that at each of two different locations along a length of shaft 102, a set of three radial arms (each arm denoted by reference numeral 104) are disposed. It is noteworthy, however, that this precise configuration is not necessary and at each location along the length of shaft 102, less or more than three radial arms may be disposed. As evident from FIG. 2, radial arms serve to connect shaft 102 to blade 106 and, therefore, if a turbine design dictates use of less or more than three blades, a corresponding number of radial arms will be deployed to facilitate the connection between the blades and shaft.

Moreover, less or more than two locations on a shaft can be configured to support radial arms. The dimensions of the blade are one important factor that drives how many radial arms are required to stabilize the blade under operation. In preferred embodiments of the present invention, however, two radial arms effectively secure each blade 106 to shaft 102.

Although turbine 100 can be adapted for use in hydrokinetic applications, it is preferably used for harnessing wind energy. To this end, blade 106 used in turbine 100 preferably is of a helical shape. The present invention recognizes that a helical shaped blade is far more efficient than conventional blade shapes to harness wind or hydrokinetic energy.

According to FIG. 2, under operation, shaft 102 is capable of rotation and is connected to an electrical generator (not shown to simplify illustration) that is housed inside hub 112. As a result, the combination of a turbine and an electrical generator, as shown in FIG. 2, effectively converts mechanical energy into electrical energy. The electrical generator may be any electrical generator known to those skilled in the art that is capable of converting mechanical energy to electricity. By way of example, an electrical generator commercially available from Ningbo Ginglon Technologies Co., Ltd., of No. 305 Penglai Road, Xiangshan Industrial Estate, Dancheng, Xiangshan Ningbo Zhejiang 315700 China, works well.

Shaft 102 is composed of any rigid material, such as steel or aluminum, that effectively provides support to and stabilizes various turbine components (e.g., radial arm 104 and blade 106) during operation. However, shaft 102 is preferably made from aluminum. Aluminum is not used in the conventional design due to metal fatigue issues. But the present invention's hinging and clamping methods permit reduced stress levels, making use of aluminum appropriate. Aluminum is preferable due to its increased stiffness and lower production costs. Further, aluminum increases the end-of-life value of a turbine because it can be melted down and reused for other applications.

Shaft 102 can have any dimensions which provide the requisite support to the various turbine components; however, the diameter of shaft 102 is preferably one that allows it to engage with hub 112, which houses the generator. Consequently, shaft 102 has a diameter that ranges between about 3 inches and about 6 inches. A length of the shaft preferably ranges between about 96 inches and about 169 inches.

Radial arm 104 is made from any material that effectively links shaft 102 and blade 106 and can sustain the connection under operation. Preferably, radial arm 104 is made from at least one member selected from a group consisting of aluminum, fiber-reinforced plastic, fiber glass, and carbon fiber. More preferably, radial arm is made from aluminum. Radial arm 104 has a length that is between about 48 inches and about 72 inches and a thickness that is between about 1 inches and about 3 inches.

Blade 106 is composed of any material that is rigid enough to handle the energy impinging upon it. Preferably, blade 106 is made from aluminum. In accordance with one embodiment of the present invention, blade 106 has a helical shape having a radius of curvature that is between about 1.0 m and about 3.0 m. A length of blade 106 is preferably between about 3.0 m and about 6.0 m and a thickness of blade 106 is preferably between about 1.0 inch and about 3.0 inches.

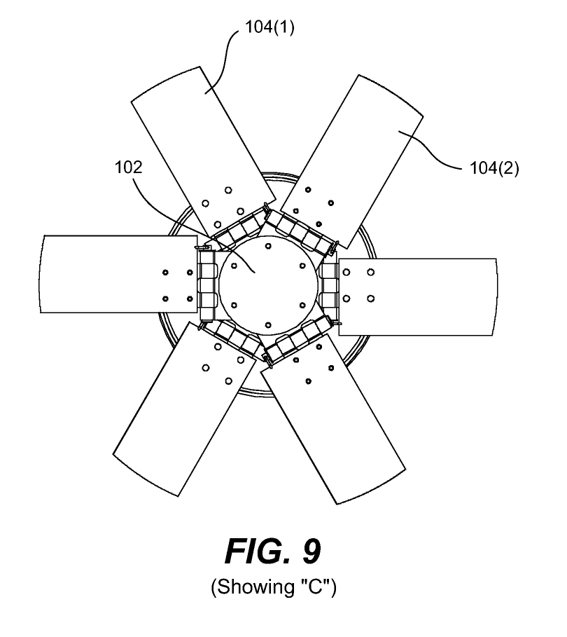

FIG. 3 shows a top view of inventive turbine 100 of FIG. 2. In the embodiment shown in FIG. 3, shaft 102 is connected to six radial arms 104. Each set two radial arms connect to blade 106 at different locations on the blade. The relative placement of radial arms 104 at different locations along a length and a radius of shaft 102 are denoted by “C,” and are shown in greater detail in FIG. 9.

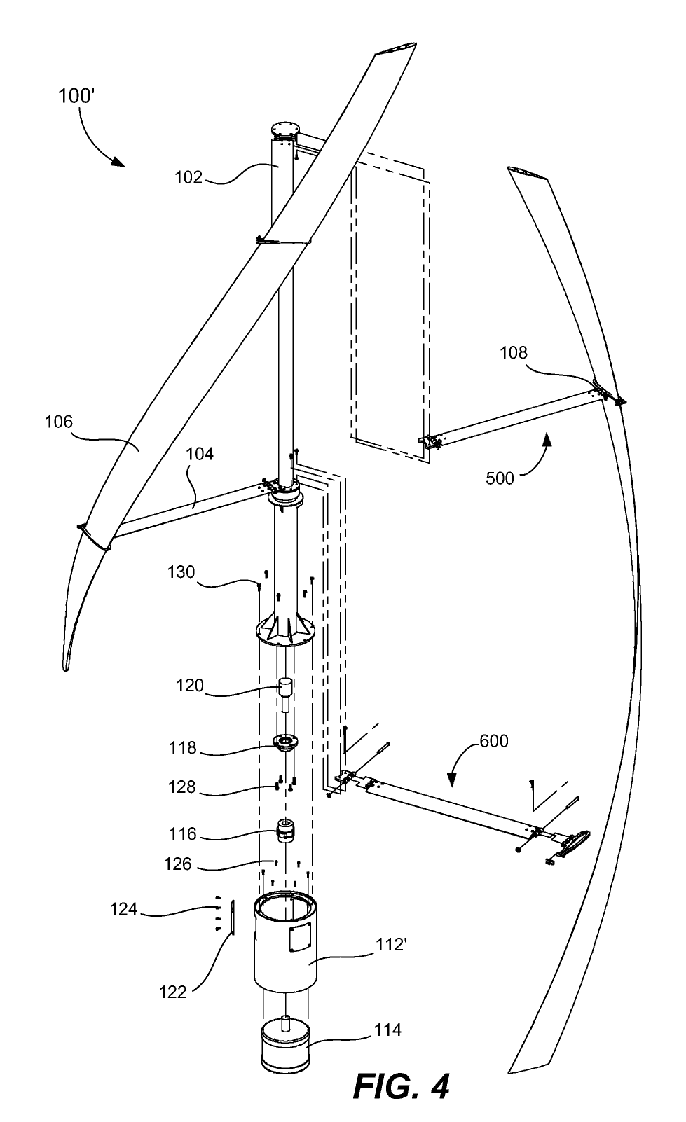

FIG. 4 shows an exploded perspective view of turbine 100□, according one embodiment of the present invention. Similar to the design shown in FIG. 2, turbine 100□ of FIG. 4 shows an assembly of similar components e.g., shaft 102, radial arm 104 and blade 106. Furthermore, FIG. 4 shows in greater detail the connection between shaft 102 and an electrical generator 114, which is housed in hub 112□, via a connecting subassembly that includes coupler 116, bearing 118, stub shaft 120, cover plate 122, and various fasteners 124, 126, 128, and 130.

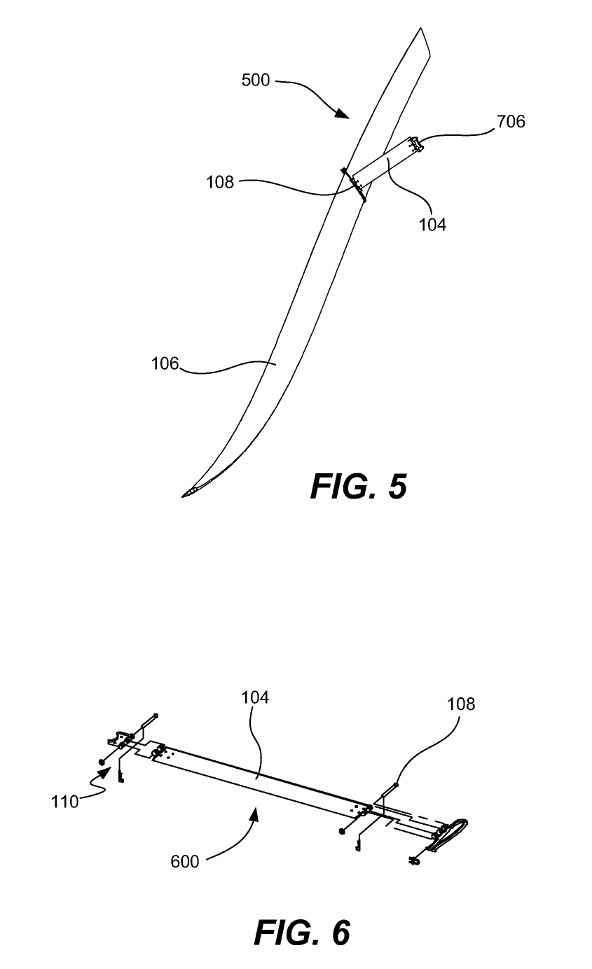

With regard to connections at different locations along a length of shaft 102, FIG. 4 shows a turbine subassembly 500 (described in greater detail below with reference to FIG. 5) with radial arm 104 connected to blade 106 via blade connecting hardware or fastener 108. FIG. 4 also shows an exploded view of subassembly 600 (described in greater detail below with reference to FIG. 6) which includes radial arm 104 and various connecting components that connect radial arm 104 to shaft 102 on one end and connect to blade 106 on the other end.

FIG. 5 shows subassembly 500, which includes blade 106 connected to one end of radial arm 104 via blade connecting hardware or fastener 108. FIGS. 7A and 7B show blade connecting hardware or fastener 108 in greater detail. According to these figures, blade connecting hardware or fastener connects to one end of radial arm 104 and has two portions, i.e., a clamp portion 704 and a hinge portion 708. As clearly shown in FIGS. 7A and 7B, clamp portion 704 of Figure B slides over blade 106. In this engaged position of hardware 108, hinge portion 708 protrudes outwardly from blade 106 and is exposed to allow connection with a hinge 706 disposed on radial arm 104. As hinge portion 708 of hardware 108 connects to hinge 706 of radial arm 104, a hinge pin 710 occupies a cavity created by the engagement of two hinges and creates a “hinge-pin connection.” In a preferred embodiment of a “hinge-pin connection” according to the present invention, each of two hinges has at least one knuckle. The knuckles engage to form a barrel shaped object, having defined therein a cavity that is capable of receiving a pin, such as the one denoted by reference numeral 710. It is noteworthy that a “hinge-pin connection” represents a preferred embodiment of the present invention, and that other similar embodiments may well be used to make connections between various components of inventive turbine assemblies.

In certain other embodiments of the present invention, pin 710 is effectively secured using additional components inside the cavity created by an engaged position of hinge portion 708 and hinge 706. By way of example, an aperture is defined near one end of hinge pin 710. A securing pin 714, which is different from hinge pin 710, is inserted through the aperture when hinge pin 710 occupies the cavity created in the engaged position of hinge portion 708 and hinge 706. Positioned inside the aperture of hinge pin 710, securing pin 714 immobilizes the hinge pin inside the cavity and further secures the connection between hinge 706 and hinge portion 708.

In an alternative embodiment of the present invention, a washer is used before securing pin 714 is inserted through the aperture. Specifically, as hinge pin 710 occupies the cavity created by the engaged position of hinge portion 708 and hinge 706, hinge pin 710 also passes through a washer 712 before securing pin 714 is inserted into the aperture. The washer provides additional protection against movement or dislodging of hinge pin 710 from the cavity to break the connection between hinge 706 and hinge portion 708.

It is noteworthy that hinge 706 disposed on radial arm 104 can be either part of radial arm 104 or, in the alternative, is connected to a radial arm. Specifically, in one embodiment of the present invention, radial arm, as fabricated, includes at least one hinge. In an alternative embodiment of the present invention, however, a plate is fabricated to include a hinge and that plate is attached or connected to one end of radial arm 104.

FIG. 6 shows an exploded view of a radial arm subassembly, according to one embodiment of the present invention, which includes a radial arm 104 that is designed to connect at one end to blade connecting hardware or fastener 108. At second end, radial arm 104 connects to shaft 102 via shaft connecting hardware 110, which is shown in greater detail in FIGS. 8A and 8B described below.

FIG. 8A focuses on an exploded view of a part of a turbine subassembly which includes a radial arm 104 and a connection between radial arm 104 and shaft 102, as shown in FIGS. 2 and 4. The connection shown in FIG. 8A is a “hinge-pin connection,” as discussed above. As shown in FIG. 8B, at one end of a radial arm, a hinge 806 is disposed. Hinge 806 is similar to hinge 706 at the other end of radial arm 104. A shaft plate has attached thereto or fabricated thereon a hinge 808 to engage with hinge 806 of radial arm. As discussed with previous “hinge-pin connection,” hinge pin 810 occupies the cavity created when the two hinges (i.e., 806 and 808) are in an engaged position. Securing pin 814 and washer 812 are assembled and operate to secure hinge pin 810 in a similar manner as securing pin 714 and washer 712 of FIG. 7B.

Shaft plate 816, which ultimately attaches to a radial arm, attaches to shaft 102 using a flange 802. As shown clearly in FIG. 8B, a pin connection fastens shaft plate 816 to flange 802.

FIG. 9 shows a detailed top view of the inventive turbine shown in FIG. 2 (i.e., the portion of FIG. 3 denoted as “C”). According to this figure, shaft 102 connects at a first location to a top tier of three radial arms and connects at a second location to a bottom tier of three radial arms. At each tier, radial arms are separated by approximately 120°. In preferred embodiments, one radial arm of the bottom tier (e.g., radial arm 104(1)) and one radial arm of the top tier (e.g., radial arm 104(2)) attach to a single blade. Preferably, the radial arms which attach to a single blade are the same length.

Although illustrative embodiments of this invention have been shown and described, other modifications, changes, and substitutions are intended. Accordingly, it is appropriate that the appended claims be construed broadly and in a manner consistent with the scope of the disclosure, as set forth in the following claims.

What is claimed is:

1. A turbine comprising:
a shaft capable of rotation along its longitudinal axis and capable of connecting to an electrical generator, and said shaft having disposed thereon at least one shaft hinge;
a radial arm including a first end having disposed thereon at least one first hinge; and
a hinge pin that fits inside a cavity formed when said at least one shaft hinge of said shaft is in an engaged position with said at least one first hinge of said radial arm, and in said engaged position said hinge pin capable of connecting said radial arm to said shaft.

2. The turbine of claim 1, further comprising a securing mechanism for immobilizing said hinge pin when it fits inside said cavity.

3. The turbine of claim 2, wherein said hinge pin is a barrel-shaped body having at a first end a head portion and having defined at a second end an aperture which extends along a diameter of said hinge pin at said second end, and wherein said securing mechanism includes a securing pin which is capable of being inserted through said aperture when said hinge pin is inside said cavity in said engaged position.

4. The turbine of claim 3, wherein said securing mechanism further comprises a washer, and in said engaged position, said hinge pin capable of being passed through said washer before said securing pin is inserted through said aperture.

5. The turbine of claim 1, further comprising a fastening assembly which includes a clamp portion and a hinge portion, said clamp portion capable of engaging with or being connected to a blade component of said turbine and said hinge portion engaging with at least one hinge disposed at a second end of said radial arm.

6. The turbine of claim 5, wherein said blade has a helical shape.

7. A turbine comprising:
a radial arm including a first end and a second end, said radial arm at said first end is capable of connecting to a shaft that is capable of rotation along its longitudinal axis and capable of connecting to an electrical generator, and said radial arm at said second end has disposed thereon at least one second hinge;
a blade that includes or has connected thereto said blade hinge; and
a hinge pin that fits inside a cavity formed when said blade hinge is in an engaged position with at least one said second hinge of said radial arm, and in said engaged position said hinge pin capable of connecting said radial arm to said shaft.

8. The turbine of claim 7, wherein said blade has a helical shape.

9. The turbine of claim 7, further comprising a securing mechanism for immobilizing said hinge pin when it fits inside said cavity.

10. The turbine of claim 9, wherein said hinge pin is a barrel-shaped body having at a first end a head portion and having defined at a second end an aperture which extends along a diameter of said hinge pin at said second end, and wherein said securing mechanism includes a securing pin which is capable of being inserted through said aperture when said hinge pin is inside said cavity in said engaged position.

11. The turbine of claim 10, wherein said securing mechanism further comprises a washer, and in said engaged position, said hinge pin capable of being passed through said washer before said securing pin is inserted through said aperture.

12. The turbine of claim 7, wherein said blade is connected to said blade hinge by a fastening assembly which includes a clamp portion and a hinge portion, said clamp portion capable of engaging with and being secured on said blade and said hinge portion including a blade hinge that engages with at least one first hinge disposed at a first end of said radial arm.

13. The turbine of claim 12, wherein said clamp portion has two legs and when said clamp portion engages with said blade, said two legs are immobilized using a u-shaped bolt.

14. A shaft capable of rotation along its longitudinal axis and which includes a first end and a second end, said first end is capable of connecting to an electrical generator, and said second end has at least one shaft hinge that is designed to connect to at least one hinge disposed on a radial arm.

15. The shaft of claim 14, wherein said second end includes three shaft hinges thereon, each shaft hinge connects to at least one hinge disposed on said radial arm.

16. A radial arm which includes a first end and a second end, said first end includes a first hinge and a second end includes a second hinge, said first hinge is capable of connecting to a shaft hinge which is part of or connected to a shaft, and said second hinge is capable of connecting to a blade hinge which is part of or connected to a blade.

17. The radial arm of claim 16, wherein said radial arm is made from at least one material selected from a group consisting of aluminum, fiber glass, carbon fiber, or fiber-reinforced plastic.

18. A fastening assembly comprising:
a clamp portion;
a hinge portion; and
wherein said clamp portion is capable of engaging with or being connected to a blade and said hinge portion is capable of engaging with at least one hinge disposed at one end of a radial arm.

19. The fastening assembly of claim 18, further comprising a u-shaped bolt, wherein said clamp portion includes two legs that are immobilized using said u-shaped bolt.

20. A method of assembling a turbine, comprising:
obtaining a fastener having a clamp portion and a hinge portion, said clamp portion capable of engaging with a blade and said hinge portion including a blade hinge;
securing said clamp portion around said blade by engaging said clamp portion around said blade;
engaging blade hinge with at least one second hinge disposed on a radial arm; and
inserting a hinge pin through a cavity formed when said blade hinge engages with at least one said second hinge disposed on a radial arm and thereby connecting said blade to said radial arm.

21. The method of claim 20, wherein at least one said second hinge is part of or connected to said radial arm.

22. The method of claim 20, wherein said securing includes:
inserting said blade through a u-shaped clamp with two legs; and
tightening said two legs to immobilize said fastener on said blade.

23. The method of claim 22, wherein said tightening includes using a u-shaped bolt to clamp said two legs.

24. The method of claim 20, further comprising immobilizing said hinge pin inside said cavity after said inserting said hinge pin through said cavity.

25. The method of claim 20, further comprising connecting at least one first hinge on said radial arm to a shaft which is capable of rotation around its longitudinal axis and capable of connecting to an electrical generator.

26. A method for assembling a turbine, comprising:
obtaining a shaft having thereon at least one shaft hinge;
engaging at least one said shaft hinge with at least one first hinge disposed on a radial arm; and
inserting a hinge pin through a cavity formed when said shaft hinge engages with at least one said first hinge disposed on a radial arm and thereby connecting said shaft to said radial arm.

27. The method of claim 26, wherein at least one said first hinge is part of or connected to said radial arm.

28. The method of claim 26, further comprising immobilizing said hinge pin inside said cavity after said inserting said hinge pin through said cavity.
